(19) United States
(12) Patent Application Publication
(10) Pub. No.: US 2004/0250578 A1
(43) Pub. Date: Dec. 16, 2004

(54) Electric cylinder for actuating a door lock and a cylinder door lock

(76) Inventor: Nobuyo Sakai, Tokyo (JP)

Correspondence Address: Gerald Levy, Pitney, Hardin, Kipp & Szuch LLP, 685 Third Avenue, New York, NY, 10014, US

(21) Appl. No.: 10/812,234

(22) Filed: Mar. 29, 2004

(30) Foreign Application Priority Data
Jun. 12, 2003 (JP) 2003/167682

(51) Int. Cl. E05B 47/00

(52) U.S. Cl. 70/277

(57) ABSTRACT

Problems of the Invention:

It is to provide an electric cylinder for actuating a door lock which may be easily attached to the existing door lock to prevent picking completely, and an electric cylinder door lock not having a keyhole.

Means for Solving the Problems:

The electric cylinder for actuating a door lock of this invention is characterized in that a motor shaft is displaced by the operation of a motor to associate a rotary can with a disc, one end of said motor shaft is accommodated in a hole portion which is formed in the bottom of the case, all electric cylinder parts are accommodated in the case, said rotary can is divided into two upper and lower parts which are always associated each other, said disc is put displaceably with a spring in the case, the pole of said motor is changed to extend and contract said motor shaft, and the tailpiece is associated with the operation of the extension and contraction to actuate a dead bolt.

### BACKGROUND OF THE INVENTION

1. Field of the Invention

This invention relates to an electric cylinder for actuating a door lock which can attach to the existing lock for opening and shutting the door.

2. Description of Related Art

The existing lock for opening and shutting the door is generally designed to use a key so that if the key has been carried and lost or is missing, picking permits the lock to be unlocked by inserting a special tool or a picking tool into the keyhole of the lock. If a lock without a keyhole is attached to the door, additional equipment which has high reparation costs is required.

Recently, a lock structure is proposed to prevent unlawful unlocking without using a proper key, for example, as disclosed in JP-A-2002-276215, however these locks must be provided on the door when it is built, or the door must be reconstructed.

### SUMMARY OF THE INVENTION

Problem to be Solved by the Invention:

It has been desired that the picking can be completely prevented by detaching the existing door lock and attaching the electric cylinder for receiving an electric signal to the door lock so as to attach easily to the existing door lock the electric cylinder which permits code operation or remote operation for sending the electric signal.

It is an object of this invention to provide an electric cylinder for actuating a door lock which may be easily attached to the existing door lock to prevent the picking completely, and an electric cylinder door lock not having a keyhole.

Means for Solving the Problems:

The electric cylinder for actuating a door lock of this invention is characterized in that a motor shaft is displaced by the operation of a motor to associate a rotary can with a disc, one end of said motor shaft is accommodated in a hole portion which is formed in the bottom of the case, all electric cylinder parts are accommodated in the case, said rotary can is divided into two upper and lower parts which are always associated with each other, said disc is put displaceably with a spring in the case, the electrode of said motor is changed to extend and contract said motor shaft, and the tailpiece is associated with the operation of the extension and contraction to actuate a dead bolt.

According to the electric cylinder for the door lock of this invention, it is to provide considerably a convenient electric cylinder which may be easily attached to the existing door lock so as to use a telephone, to provide the remote operation from one's room of house or apartment, or to provide a locking and unlocking lock which may be operated with a fingerprint and a tenkey.

According to the electric cylinder for the door lock of this invention, wiring cables of a motor for extending and contracting the shaft, or a stepping motor are disposed at the position regardless of the rotation of the rotary dish plate, so that the cylinder may be rotated at an angle of more than 360° to correspond to foreign locks such as European locks and the like.

The electric cylinder for the door lock of this invention is characterized in that the electric cylinder may be easily attached to the existing door lock by clamping bolts from the front side of the existing door to provide the electric cylinder door locks not having a keyhole.

### SIMPLE DESCRIPTION OF DRAWINGS

FIG. 1 shows the whole exploded view of the electric cylinder;

FIG. 2 shows a perspective view where all parts of the electric cylinder are accommodated in the case to be assembled and associated with the dead bolt of the existing door;

FIG. 3 shows a plan view where the electric cylinder is set to the existing door opening and shutting lock;

FIG. 4 shows a partial perspective view of upper and lower rotary can parts for the motor provided with a screwed shaft; and

FIG. 5 shows a partial perspective view of the whole exploded electric cylinder provided with a motor and a rotary dish plate to rotate the electric cylinder at an angle of more than 360 degrees.

### DETAILED DESCRIPTION OF THE PREFERRED EMBODIMENTS

The preferred embodiments of the invention will be illustrated hereinafter with reference to the accompanying drawings.

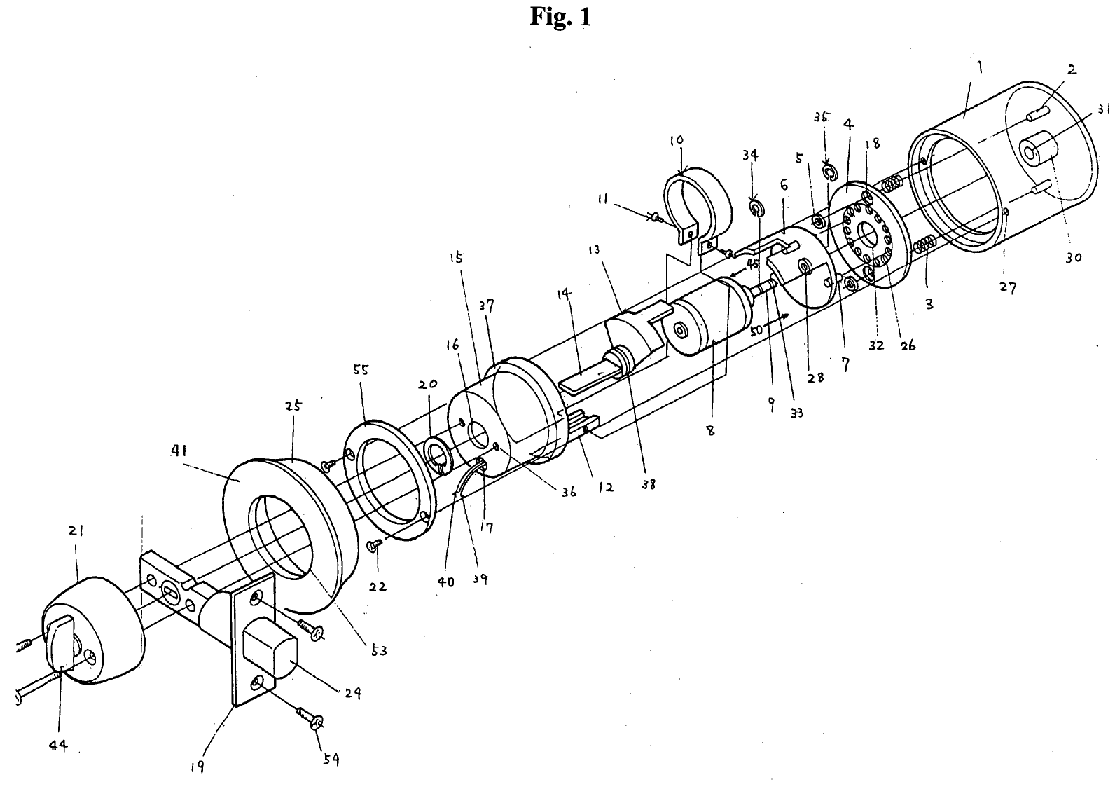

FIG. 1 shows the exploded parts of the whole of the electric cylinder in the perspective view. The electric cylinder mechanism is illustrated in the exploded perspective view. Plural stand poles 2 along which springs 3 are winded, are fixed to the bottom of a case 1. A disc 4 is secured to the plural poles 2 by rings 5 when the plural poles 2 are passed through holes 18 of the disc 4. A hollow pole 30 provided with the bottom of the case 1 is inserted into a central hole 32 of the disc 4.

A shaft 9 associated with a motor 8 is inserted in a central hole 28 of the bottom of a lower rotary can part 6, and when the lower rotary can part 6 and the motor 8 are connected by stop rings 34 and 35 set in two grooves 33 notched on the shaft 9, the shaft 9 is entered in a hole 31 of the central hole 30 provided on the bottom of the case 1 to arrange the motor 8 and the case 1 in a linear relation. This motor 8 is a stepping motor which can extend and contract the shaft 9 in the arrow directions 50 and 45.

The motor 8 is integrated with a stationary can 15. The cables 39 and 40 are drawn from holes 17 of the stationary can 15 through the cable through grooves of a projected portion. The motor 8 is clamped by a stationary metal fitting 10 and attached to the stationary can 15 by bolts 11. An upper rotary can part 13 is integrated through a cylinder part 38 with a tailpiece 14 which is associated with a dead bolt for a door lock. The upper rotary can part 13 is secured to the stationary can 15 by clamping a ring to a groove formed on the cylinder part 38 to pass the tailpiece 14 through a central hole 16 opened in the stationary can 15.

The stationary can 15 integrated with the upper rotary can part 13 by a clamping ring 20 is pushed by means of a ring plate 55 and accommodated in the case 1, because bolts 22 are secured through the hole of the ring plate 55 into screwed holes 27 of the case 1. Then, the ring plate 55 is set on a step face 37 of the stationary can 15 to be completely integrated with the case 1. The stationary can 15 of the integrated electric cylinder is passed through a central hole 53 of a decorative seat block 25 and integrated with the decorative seat block 25 to contact the surface 41 of the decorative seat block 25 with the door surface. An inner case 21 for a door lock is attached to the stationary can 15 by inserting bolts 13 through a dead bolt 24 for the door lock into the screwed holes 36 of the stationary can 15.

The electric operation will be illustrated with reference to the accompanying drawings; the two cables 39 and 40 for a power source are used in the motor 8. When the positive electrode is connected to the cable 39 and the negative electrode is applied to the cable 40, the shaft associated with the motor 8 is displaced in the direction of the arrow 50 to push the rotary lower can part 6 associated with the shaft 9 to enter a projection 7 integrated with the rotary lower can part 6 into a number of holes 26 opened on the disc 4 accommodated in the case 1.

At this state, when the case is turned by hand, the rotary lower and upper can parts 6 and 13 are associated with each other and turned together through groove faces 42 to transmit a turning movement to the tailpiece 14, so that the dead bolt 24 is actuated to provide an unlocking state. However, when the dead bolt 24 is contacted to a socket of the door (not shown), the dead bolt 24 is not actuated to the normal position. In this case, as the cylinder case 1 is continued to turn by hand, springs 3 are contracted, and when a further constant power is applied to the engaging portions, or projections 7 of the rotary can part 6 and holes 26 of the disc 4, the projections 7 are detached from the holes 26 because at least one of the projection 7 and the hole 26 is provided with the inclined angle, so that the cylinder case 1 is turned by hand force to generate a clicking sound (click-clack).

When one cable 39 is connected to the negative electrode and the other cable 40 is connected to the positive electrode, the shaft 9 of the motor 8 is returned in the arrow direction 45 to detach the rotary lower can part 6 from the disc 4 so as to permit them both to be unassociated. The spring 3 is functioned to escape the pushing movement because the disc 4 is pushed toward the bottom of the case if the rotary lower can part 6 may be badly engaged with the disc while the shaft is displaced in the arrow direction 50. Moreover, during locking, plural holes 26 opened on the disc 4 are not engaged and connected with the projections 7 integrated with the rotary lower can part 6, so as to always provide the free-rotation of the cylinder case 1.

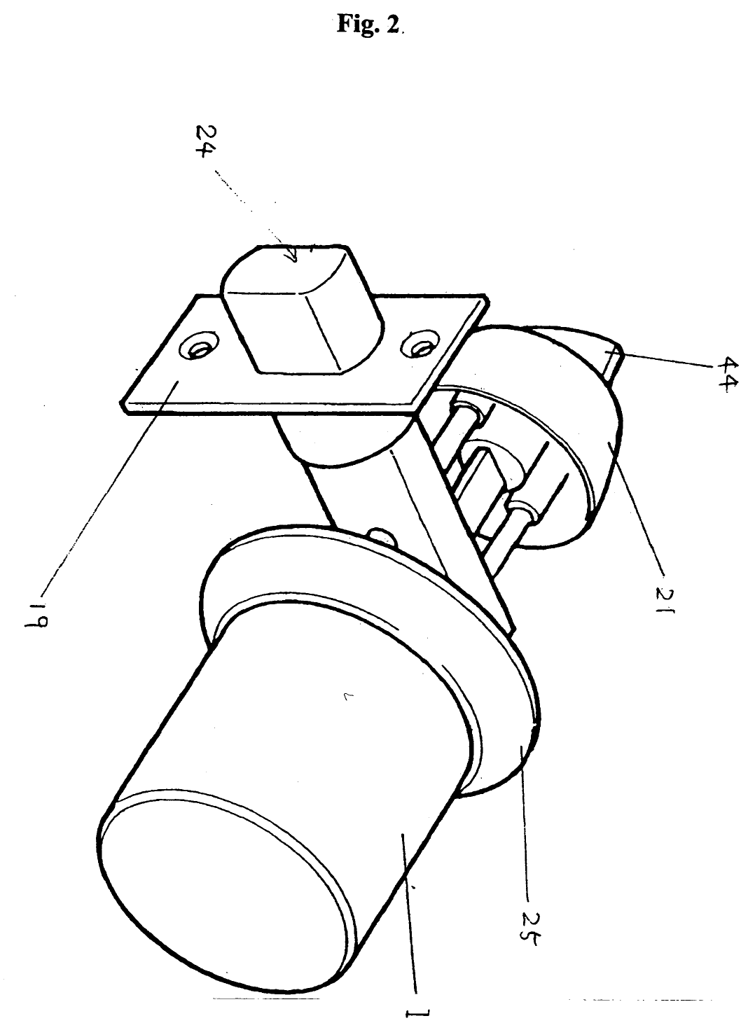

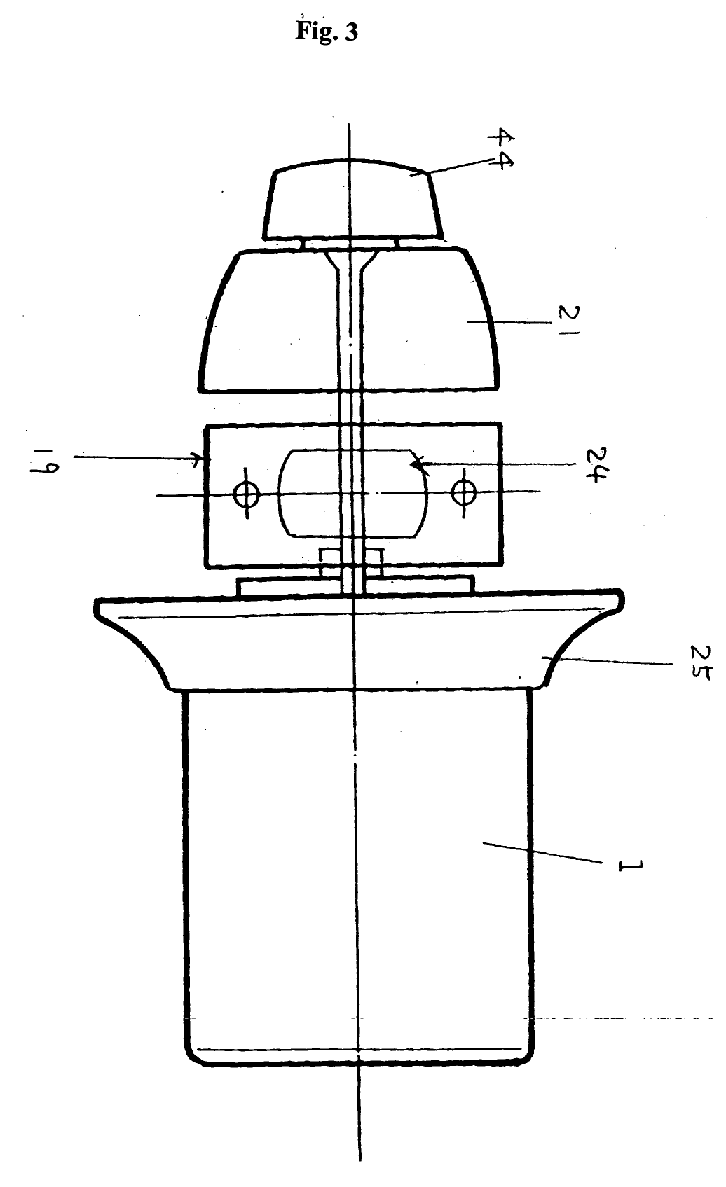

FIG. 2 and FIG. 3 show a perspective view and a plan view for the assembled state where a dead bolt for opening and shutting the door lock is associated with the cylinder case 1 for accommodating all parts of the electric cylinder. The opening and shutting is carried out by turning an opening and shutting knob 44 with fingers to displace the dead bolt 24 within a door.

When the dead bolt 24 is inserted through a door dead bolt guide 19 into a locking hole provided on the wall, the door is locked. The knob 44 is turned from the locking hole so as to provide the unlocking state. The dead bolt guide 19 is fixed to the end face of the door by bolt 54.

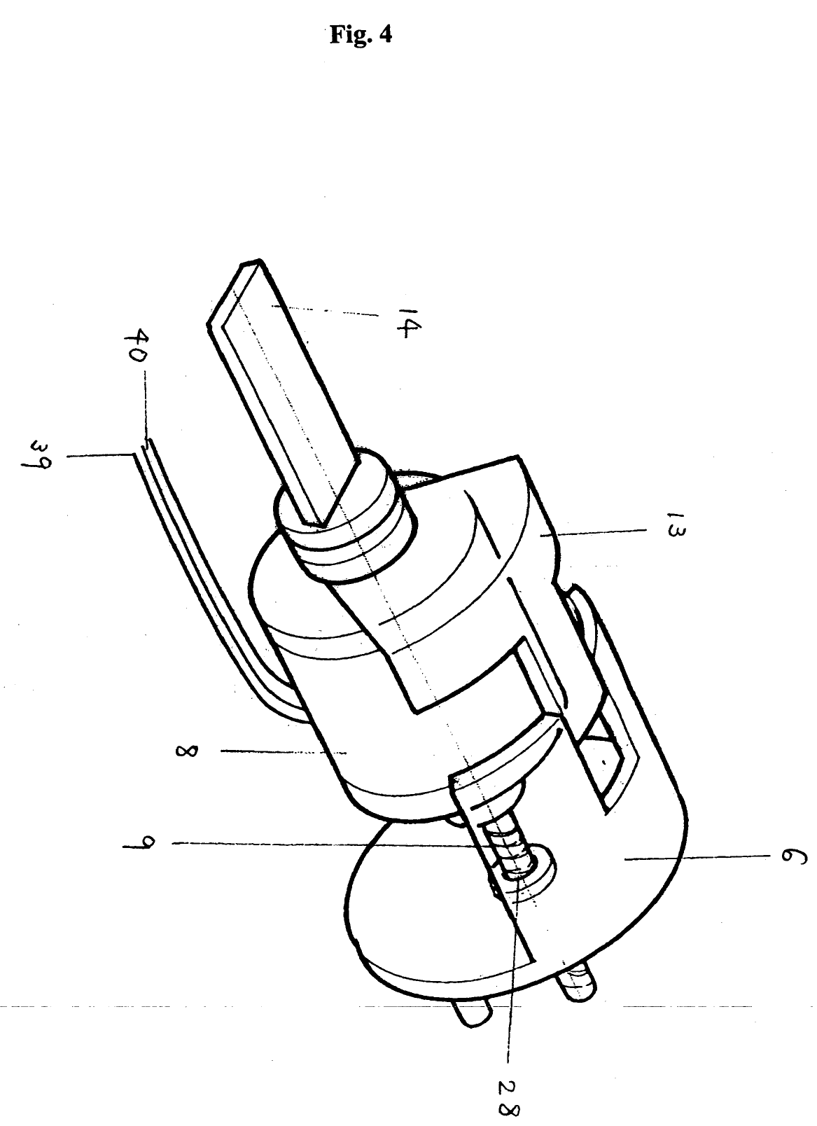

FIG. 4 shows a partial perspective view of rotary upper and lower can parts for using a screwed motor shaft. The shaft 9 of the motor 8 is screwed and the hole 28 of the lower can part 6 is screwed, so that when the shaft 9 is rotated, the rotary lower can part 6 engaged with the shaft 9 is advanced at the positive electrode to be associated with the disc 4. As the negative electrode is connected to the motor, the rotary lower can part 6 is detached from the disc 4, or the shaft 9 of the motor 8 is not extended and contracted. The shaft 9 and the hole 28 of the rotary lower can part 6 are respectively provided with screws, so that the rotary lower can part 6 is reciprocated and associated with the disc 4.

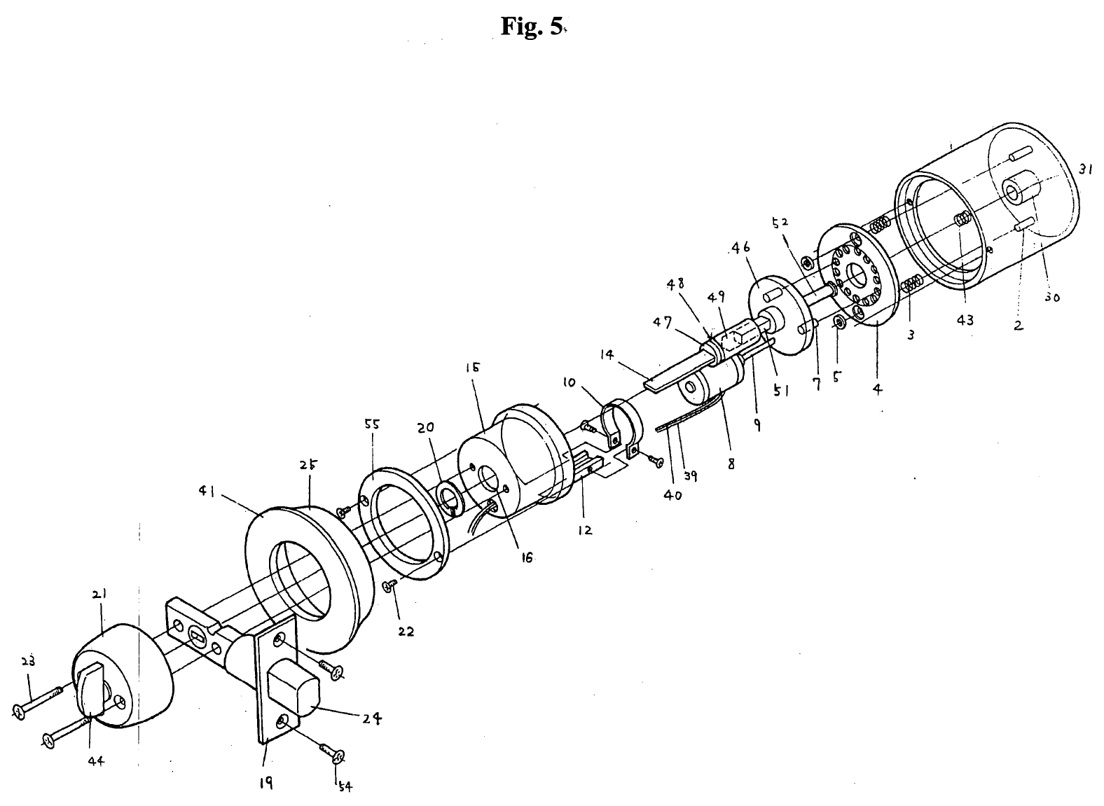

FIG. 5 shows a partial perspective view of a whole exploded electric cylinder provided with the motor 8 and the rotary dish plate 46, the electric cylinder may be rotated under an angle of more than 360 degrees.

The shaft 9 of this stepping motor 8 is disposed in parallel to the tailpiece assembly and contacted with the surface of the rotary dish plate 46. One side of the rotary dish plate 46 is provided with a movable rectangular rod 51 and the other side of the rotary dish plate 46 is provided with a cylindrical rod 52 which is inserted through a spring 43 into a hole 31 of a hollow pole 30. The one movable rectangular rod 51 is associated with a cylinder 47 having a slide hole 49 of the tailpiece assembly in the piston-cylinder relation.

The tailpiece 14 associated with the rotary dish plate 46 is disposed in parallel to the stepping motor 8, so that the cables 39 and 40 drawn from the stepping motor 8 do not hinder the rotation of rotary dish plate 46. Accordingly, the electric cylinder may be rotated at the more than 360 degrees. After the tailpiece 14 is inserted through the hole 16 into the rotary cylinder 15, when the ring 20 is clamped in an annular groove 48 provided on the cylinder 17 of the tailpiece assembly, the tailpiece assembly is fixed in the rotary cylinder 15. The disc 4, the rotary dish plate 46, the tailpiece assembly and the rotary cylinder 15 are disposed in a linear relation and accommodated in the case 1.

When the one cable 39 is connected to the positive electrode and the other cable 40 is connected to the negative electrode, the shaft 9 associated with the motor 8 is displaced in the arrow direction 50 as shown in FIG. 1, to push the rotary dish plate 46 associated with the shaft 9, so that the projections 7 integrated with the rotary dish plate 46 are entered into plural holes 26 opened on the disc 4 which is accommodated in the cylinder case 1. In this state, turning the cylinder case 1 by hand, the turning movement permits the disc 4 and the rotary dish plate 46 to be associated with each other and transmitted through the rectangular rod 51 of the rotary dish plate 46 and the slide hole 59 provided in the cylinder 47 of the tailpiece assembly to the tailpiece 14, so that the dead bolt 24 is actuated to provide an unlocked state. However, when the dead bolt 24 is contacted to a socket of the door (not shown), the dead bolt 24 is not actuated to the normal position. In this case, as the cylinder case 1 is continued to turn by hand, springs 3 are contracted, and when a further constant power is applied to the engaging portions, or projections 7 of the rotary dish plate 46 and holes 26 of the disc 4, the projections 7 are detached from the holes 26 because at least one of the projections 7 and holes 26 is provided with the inclined angle, so that the cylinder case 1 is turned by hand force to generate a clicking sound (click-clack).

Effects of the Invention:

According to this invention, the electric cylinder may be easily attached to the existing door lock to prevent picking completely.

This invention is to provide the electric cylinder door lock not having a keyhole with a means of easily attaching the cylinder to the existing door opening and shutting lock from the front side of the door by clamping the bolts. According to the electric cylinder for actuating the door lock of this invention, the cables of the stepping motor do not hinder the rotation of the rotary dish plate which is based on the locking and unlocking operations for carrying out the rotation of the electric cylinder, so that this electric cylinder may be adapted to use in foreign cylinder locks such as European cylinder locks so as to turn it at an angle of more than 360 degrees.

According to the electric cylinder for actuating the door lock of this invention, the electric cylinder may be easily attached to the existing door locks. Using the telephone or the remote operation from one's room, and moreover using the fingerprints and the tenkeys, the electric cylinder may be used in the locking and unlocking lock.

According to this invention, during unlocking operation when a further constant force is applied to this electric cylinder, the associated engagement of the rotary can or dish plate and the disc is detached from each other, so that the cylinder case may be free-rotated in manual operation.

### DESCRIPTION OF REFERENCE NUMBERS

1 . . . a cylinder case

2 . . . stand poles

3 . . . springs

4 . . . a disc

5 . . . clamping rings

6 . . . a lower rotary can part

7 . . . projections

8 . . . a motor

9 . . . a shaft

10 . . . a clamping metal fitting

11 . . . bolts

12 . . . a cable passing groove

13 . . . an upper rotary can part

14 . . . a tailpiece

15 . . . a stationary can

16,17,18 . . . holes

19 . . . a dead bolt guide for a door

20 . . . a clamping ring

21 . . . an inner case for a lock

22,23 . . . bolts

24 . . . a dead bolt

25 . . . a decorative seat block

26 . . . a number of holes

27 . . . a hole

28 . . . a central hole of a lower rotary can part

29 . . . engaging grooves

30 . . . a hollow pole

31 . . . a hole of a hollow pole

32 . . . a central hole

33 . . . grooves of a shaft

34 . . . a clamping ring

35 . . . a clamping ring

36 . . . a screwed hole

37 . . . a set portion of a stationary can part

38 . . . a cylinder portion

39,40 . . . cables for positive and negative electrodes

41 . . . a surface of a decorative seat block

42 . . . a groove face

43 . . . a spring

44 . . . an opening and shutting knob

45 . . . an arrow

46 . . . a rotary dish plate

47 . . . a tailpiece cylinder

48 . . . an annular groove of a tailpiece cylinder

49 . . . a slide hole of a tailpiece cylinder

50 . . . an arrow

51 . . . a rectangular rod of a rotary dish plate

52 . . . a cylindrical rod of a rotary dish plate

53 . . . a central hole of a decorative seat block

54 . . . bolts

55 . . . a ring plate

What is claimed is:

1. An electric cylinder for actuating a door lock, characterized in that a motor shaft is displaced by the operation of a motor to associate a rotary can with a disc, one end of said motor shaft is accommodated in a hole portion which is formed in the bottom of the case, all electric cylinder parts are accommodated in the case, said rotary can is divided into two upper and lower parts which are always associated with each other, said disc is put displaceably with a spring in the case, the electrode of said motor is changed to extend and contract said motor shaft, and the tailpiece is associated with the operation of the extension and contraction to actuate a dead bolt.

2. An electric cylinder for actuating a door lock according to claim 1,
wherein a screwed motor shaft is set in the screwed hole of the lower rotary can part for receiving said motor shaft.

3. An electric cylinder for actuating a door lock, characterized in that the tip of a motor shaft is contacted with the surface of a rotary dish plate and said motor shaft is displaced by the operation of said motor to associate said rotary dish plate with a disc; said tailpiece associated with said rotary dish plate is arranged in parallel to said motor, so that cables drawn out from said motor do not hinder the turning movement of said rotary dish plate; said disc, said rotary dish plate, said tailpiece and a stationary can are disposed in a linear relation and all electric cylinder parts are accommodated in the case; said disc is put displaceably with a spring in the case; the electrode of said motor is changed to extend and contract said motor shaft, and the tailpiece is associated with the operation of the extension and contraction to actuate a deadbolt.

4. An electric cylinder for actuating a door lock according to either one from claim 1 to claim 3, wherein either one of the associated locking parts of said rotary can or said rotary dish plate and said disc is provided with an inclined angle.

5. An electric cylinder door lock according to either one of from claim 1 to claim 4, wherein said electric cylinder is attached to the existing door lock by clamping bolts to provide a cylinder door without a keyhole.
